(19) United States
(12) Patent Application Publication
(10) Pub. No.: US 2001/0015094 A1
(43) Pub. Date: Aug. 23, 2001

(54) Viscosity measuring apparatus

(75) Inventor: Yasunori Konaka, Uji-shi (JP)

Correspondence Address: KANESAKA AND TAKEUCHI, 1423 Powhatan Street, Alexandria, VA, 22314, US

(73) Assignee: SHIMADZU CORPORATION

(21) Appl. No.: 09/771,711

(22) Filed: Jan. 30, 2001

(30) Foreign Application Priority Data
Feb. 22, 2000 (JP) 2000-044662

(51) Int. Cl. G01N 11/14

(52) U.S. Cl. 73/54.32; 73/54.28

(57) ABSTRACT

A viscosity measuring apparatus of the invention is provided with a memory for storing numeric data corresponding to a plurality of sampling conditions set in advance, and an operating device or a data calling key for calling data in the memory. By operating the operating device or key, the necessary data, such as a plurality of Mooney values or plurality of scorch times set in advance, is displayed as numeric values in a display at any time during the test. Therefore, during the test, a user of the apparatus can determine whether the test should be continued or not, or analyze the data.

### BACKGROUND OF THE INVENTION AND RELATED ART STATEMENT

The present invention relates to a viscosity measuring apparatus for measuring a viscosity of a high polymer material, such as rubber, and more particularly, the present invention relates to a viscosity measuring apparatus which obtains a viscosity of a sample by measuring a viscosity resistance of the sample.

As one of methods for evaluating a viscosity of a high polymer material, such as rubber, there has been known a method for measuring Mooney viscosity. As indicated in JIS (Japanese Industrial Standard) K6300, measuring the Mooney viscosity is carried out as follows. Namely, a cylindrical space is formed as a sample chamber between upper and lower dies, a temperature of which can be controlled, and a rotor is disposed at a center portion of the sample chamber. Here, in the condition that the sample chamber is filled with a sample to be measured and a temperature in the sample chamber is kept at a predetermined temperature, the rotor is rotated at a specific rotational frequency, so that a counter torque of the rotor generated by a viscosity resistance of the sample is detected by a load cell. For example, in the test for raw rubber, a measured value of the counter torque, which is measured when a period of time set in advance has elapsed after starting the test, is obtained as the Mooney value. In the test for vulcanized rubber or the like, a period of time until a measured value of the counter torque reaches a value set in advance, is obtained as scorch time.

In this kind of the conventional viscosity measuring apparatus, in case there are plural Mooney values or plural scorch times, which are desired to be obtained by measurements, that is, in case a Mooney value MV1 after four minutes, a Mooney value MV2 after eight minutes, and a Mooney value MV3 after ten minutes as shown in FIG. 3(A) are desired to be obtained, or in case first scorch time ST1 and second scorch time ST2 as shown in FIG. 3(B) are desired to be obtained, a plurality of data samplings or collecting conditions is set when the test conditions are set, so that data corresponding to the respective set conditions is memorized or stored. Thus, after the test is finished, the data is outputted as numeric data in a batch to, for example, a printer or the like, to print.

In the conventional viscosity measuring apparatus described above, a current value for the Mooney value or elapsed time during the test is displayed. However, it is impossible to know numeric data at a middle point corresponding to the data collecting condition, which is set in advance before the test. Therefore, a quick determination can not be made as to whether the test after the middle point should be continued based on the result at the middle point during the test. Also, an analysis using the result at the middle point can not be made during the test.

Accordingly, an object of the invention is to provide a viscosity measuring apparatus, by which a user of the apparatus is able to know, at any time, desired numeric data at a middle point during the test.

Further objects and advantages of the invention will be apparent from the following description of the invention.

### SUMMARY OF THE INVENTION

To achieve the aforementioned object, the present invention provides a viscosity measuring apparatus, which comprises a sample chamber formed between an upper die and a lower die and accommodating a sample therein; a rotor disposed in the sample chamber and rotated in a condition that the sample chamber is filled with the sample and kept at a predetermined temperature such that a counter torque generated by a viscosity resistance of the sample is measured at every moment to obtain a viscosity of the sample; a memory for storing measured values of counter torques at plural points of elapsed time set in advance, or elapsed times when the counter torque reaches plural counter torque values set in advance; operating means for calling any of data stored in the memory; and displaying means for displaying the data called by the operating means as a numeric value. In the viscosity measuring apparatus of the invention, the displaying means can display numeric data corresponding to a plurality of data sampling conditions set in advance at any time while measuring the viscosity.

In the present invention, data which corresponds to a plurality of data collecting conditions set in advance and is stored in the memory, for example, Mooney values after four minutes, after eight minutes, and after ten minutes, or first scorch time and second scorch time, can be called at any time during the test (while measuring the viscosity) by operating the operating means and displayed as numeric data in the displaying means. Thus, a user of the apparatus is able to know the desired numeric data at any time during the test. Accordingly, it is possible to carry out a determination whether the test should be continued, or an analysis of data, in the test.

### BRIEF DESCRIPTION OF THE DRAWINGS

FIG. 1 is a structural diagram of a viscosity measurement apparatus of an embodiment of the present invention, wherein a mechanical structure and a block diagram showing an electrical structure are combined;

FIG. 2 is a schematic view showing an example of a display screen of a display shown in FIG. 1; and

FIGS. 3(A) and 3(B) are graphs for explaining examples of a plurality of data generally obtained in Mooney test, wherein

FIG. 3(A) is a graph showing an example of a plurality of Mooney values, and

FIG. 3(B) is a graph showing an example of a plurality of scorch times.

### DETAILED DESCRIPTION OF PREFERRED EMBODIMENTS

Hereunder, preferred embodiments of the invention will be explained with reference to the attached drawings.

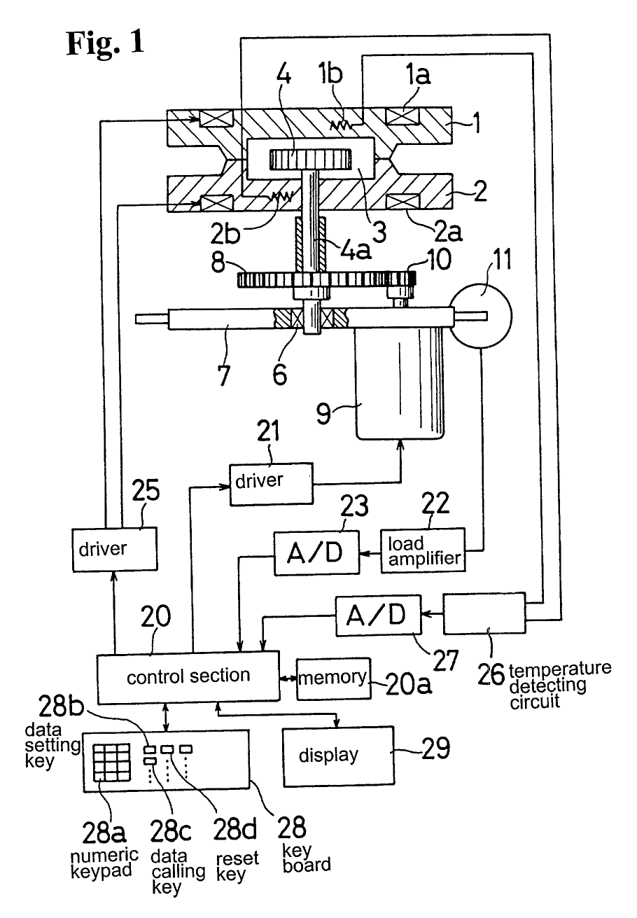

FIG. 1 is a structural view of a viscosity measurement apparatus of an embodiment of the invention, and in FIG. 1, a mechanical structure and a block diagram showing an electrical structure of the apparatus are combined.

In the apparatus of the embodiment, a sample chamber 3 having a cylindrical space is formed between an upper die 1 and a lower die 2, and a rotor 4 is disposed at a center portion in the sample chamber 3. The rotor 4 is fixed to an upper end of a rotor shaft 4a which liquid-tightly passes through the lower die 2, and the rotor shaft 4a is rotatably supported by a supporting plate 7 through a bearing 6 in a vicinity of a lower end of the rotor shaft 4a. Also, a driven gear 8 is fixed to the rotor shaft 4a, and the driven gear 8 engages a driving gear 10 fixed to an output shaft of a driving motor 9, so that rotation can be applied to the rotor 4 by driving the driving motor 9. The driving of the driving motor 9 is controlled by a control signal supplied from a driver 21 which is operated based on a command signal from a control section 20, which is mainly formed of a microcomputer.

The supporting plate 7 supports the rotor shaft 4a through the bearing 6 as described above, and at the same time, the supporting plate 7 itself is rotatably supported around the bearing 6. Also, an outer rim of the supporting plate 7 is engaged with a force sensitive section of a load cell 11. In this structure, a counter torque generated by providing a rotation to the rotor 4 rotates the supporting plate 7 around the bearing 6 through the rotor shaft 4a. By the rotation of the supporting plate 7, the force sensitive portion of the load cell 1 is pressed, so that the counter torque working on the rotor 4 can be detected from an output of the load cell 11. After the output of the load cell 11 is amplified by a load amplifier 22, the output of the load cell 11 is digitized by an analog/digital converter 23, and is sampled at the control section 20 at every moment.

In both the upper die 1 and the lower die 2, heaters 1a and 2a and temperature sensors 1b and 2b are respectively provided, and driving of the respective heaters 1a and 2a is controlled by control signals supplied from a driver 25 under the control of the control section 20. Also, after outputs of the respective temperature sensors 1b and 2b pass through a temperature detecting circuit 26 and are digitized by an analog/digital converter 27, the outputs are taken into the control section 20 at every moment. In the control section 20, by using the outputs of the respective temperature sensors 1b and 2b, control signals which should be supplied to the heaters 1a and 2a are determined such that the output values of the temperature sensors 1b and 2b, i.e. temperature of the sample chamber 3 surrounded by the upper die 1 and the lower die 2, agree with a predetermined temperature which is set by a keyboard 28 in advance, and a command is given to the driver 25.

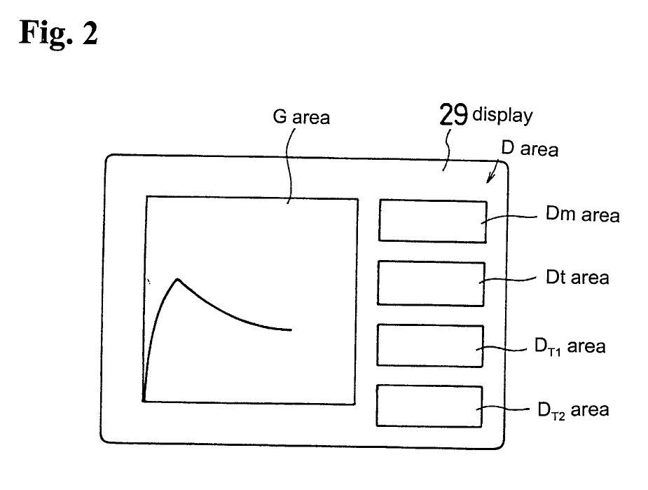

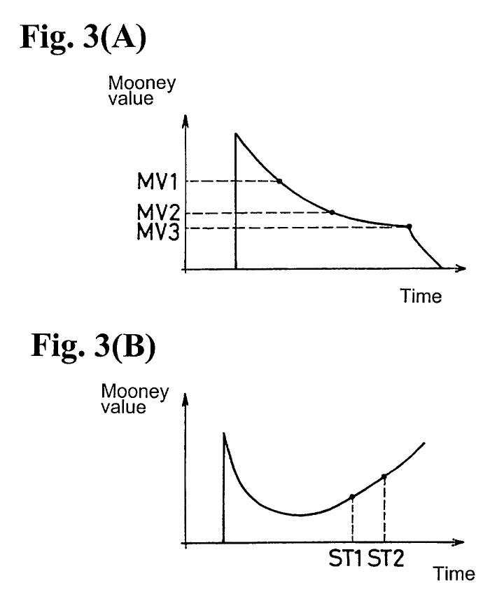

A display 29 is connected to the control section 20, and as shown in the example of a display screen of the display in FIG. 2, the display 29 has an area G displaying a graph showing a relationship between time elapsed after starting the test and Mooney values (measured values of the counter torque), and an area D displaying numeric values of various data. The area D displaying the numeric data is formed of an area Dm showing a numeric value of the Mooney value at a present time; an area Dt showing a numeric value of time elapsed from a start of the test to the present; and areas D_{T1} and D_{T2} showing numeric values of temperatures of the upper die 1 and the lower die 2 at the present time.

In the keyboard 28, other than a numeric keypad 28a, there is provided a necessary data setting key 28b for setting a plurality of data, which should be obtained by the test, before the test. For example, in the test for raw rubber, it is set to collect respective Mooney values when a time elapsed after starting a test reaches plural points of time, and in the test for vulcanized rubber, it is set to collect respective scorch times until the Mooney value reaches respective plural values. In the control section 20, data corresponding to the plurality of conditions set as described above are stored in corresponding areas set in a memory 20a.

In the keyboard 28, there is formed a data calling key 28c for calling the necessary data, which is to be stored in the memory 20a during the test, at any time during the test. By operating the key 28c, the necessary data, which has stored in the memory 20a so far, is displayed in the corresponding areas. For example, regarding the Mooney value, a Mooney value after four minutes and a Mooney value after eight minutes are sequentially shown in the area Dm instead of the current Mooney value, and regarding the scorch time, first scorch time and second scorch time are sequentially shown in the area Dt instead of the current elapsed time. Furthermore, in the keyboard 28, there is formed a reset key 28d, which is operated in the condition that the necessary data is displayed as described above, so that the display of the necessary data is returned to the current value.

Also, the keyboard 28 is provided with a key, not shown, for displaying a maximum Mooney value or a minimum Mooney value, and a key, not shown, for switching a display screen of the display 29 reversibly from a screen, which displays the graph and the various digital values together as shown in FIG. 2, to a screen which displays only the magnified digital values.

In case the test is carried out by using the embodiment of the invention described above, firstly, the test conditions, such as test temperature, rotational frequency of the rotor 4, and duration of the test, are set, and at the same time, the necessary data is set. Thereafter, in the condition that the temperature inside the sample chamber 3 filled with the sample is kept at the test temperature, the rotor 4 is rotated to start the test. During the test, the counter torque, which works on the rotor 4 due to the viscosity resistance of the sample, is detected by the load cell 11 at every moment, and stored in the memory 20a. At the same time, when the set condition of the necessary data is fulfilled, the data thereof is stored in the memory 20a. Also, meanwhile, as shown in FIG. 2, in the display 29, a graph showing a relationship between the Mooney value at every moment and time which has passed after starting the test is displayed in the area G, and at the same time, the Mooney value, elapsed time, and temperature at real time are displayed as numeric values in the corresponding positions in the area D.

Then, in the display condition during the test described above, by operating the calling key 28c, the necessary data, which has stored in the memory 20a up to then, is displayed as numeric values in the corresponding positions in the area D. Accordingly, the user of the apparatus of the invention is able to know the necessary data at a middle point during the test at any time, and during the test, the user can determine whether the test should be continued or not, or can carry out the analysis for the sample.

Also, if the maximum Mooney value or the minimum Mooney value is displayed by the key operation, information for the determination or the analysis described above can be provided further sufficiently. Furthermore, regarding the display of the numeric values of the necessary data, the maximum value and the minimum values, if the numeric values are enlarged and displayed in the screen of the display 29 according to the necessity, there is an advantage that the apparatus is easily used since the necessary data can be seen more easily.

According to the present invention, the apparatus of the invention is structured such that the Mooney values corresponding to the plurality of elapsed times set in advance, or the plurality of scorch times can be displayed as numeric values at any time during the test. Thus, until the test is completed, a user of the apparatus can carry out the determination whether the test should be continued, or the analysis of the sample based on the data at the middle point. Accordingly, a working efficiency especially in the test for the sample which requires a long time for the test can be improved.

While the invention has been explained with reference to the specific embodiments of the invention, the explanation is illustrative and the invention is limited only by the appended claims.

What is claimed is:

1. A viscosity measuring apparatus for measuring a viscosity of a sample, comprising:
a sample chamber for accommodating a sample,
a rotor disposed in the sample chamber, said rotor being rotated in a condition that the sample chamber is filled with a sample,
means for measuring a counter torque generated by a viscous resistance of the sample, said measuring means being connected to the rotor to obtain a viscosity of the sample,
a memory electrically connected to the measuring means for storing measured data at plural data collecting conditions set in advance,
operating means electrically connected to the memory for calling one of the data stored in the memory, and
displaying means electrically connected to the operating means for displaying the data called by the operating means as a numeric value, said displaying means being capable of displaying the numeric value at any time while measuring the viscosity.

2. A viscosity measuring apparatus according to claim 1, wherein said data collecting conditions include plural points of elapsed time after starting of measurement of the viscosity, in which said data includes values of the counter torque at the respective plural points of the elapsed time, and plural values of the counter torque, in which said data includes elapsed times when the counter torque reaches the respective plural values of the counter torque.

3. A viscosity measuring apparatus according to claim 2, wherein said sample chamber is formed of upper and lower dies having heat sensors for measuring temperature thereof, and heaters attached to the upper and lower dies for heating the same so that the sample chamber keeps the sample at a predetermined temperature.

4. A viscosity measuring apparatus according to claim 3, wherein said memory includes a control section connected to the heat sensors and heaters for controlling the same.

5. A viscosity measuring apparatus according to claim 4, wherein said measuring means includes a support plate for rotationally supporting a shaft of the rotor, and a load cell attached to the shaft.
